(19) United States
(12) Patent Application Publication
(10) Pub. No.: US 2016/0131081 A1
(43) Pub. Date: May 12, 2016

(54) ELECTRIC THRUST REVERSER SYSTEM FOR AN AIRCRAFT ENGINE NACELLE AND AIRCRAFT ENGINE NACELLE EQUIPPED WITH SAME

(71) Applicant: AIRCELLE, GONFREVILLE L'ORCHER (FR)

(72) Inventors: Hakim MAALIOUNE, ORGEVAL (FR); Alexandre DESCAMPS, PARIS (FR); Pierre MORADELL-CASELLAS, SAINT GEORGES DES GROSEILLERS (FR)

(73) Assignee: AIRCELLE, GONFREVILLE L'ORCHER (FR)

(21) Appl. No.: 14/996,822

(22) Filed: Jan. 15, 2016

Related U.S. Application Data
(63) Continuation of application No. PCT/FR2014/051837, filed on Jul. 17, 2014.

(30) Foreign Application Priority Data
Jul. 17, 2013 (FR) 13/57005

(51) Int. Cl. F02K 1/76

(52) U.S. Cl. CPC F02K 1/763; F02K 1/766

(57) ABSTRACT

The present disclosure provides an electric thrust reverser system for an aircraft engine nacelle, including a mechanism for actuating a thrust reverser mechanism. The actuating mechanism includes a first drive cylinder and a second drive cylinder. Each cylinder includes a mechanical connection casing, a primary lock (8) and a movable rod secured to a point connected to the associated thrust reverser mechanism. A motor-actuated drive unit is mechanically connected, via flexible shafts, to the mechanical connection casings of each drive cylinder and set in motion by the command of a control unit via an electrical connection. A tertiary lock is disposed for securing the associated thrust reverser mechanism, to a fixed structure of the nacelle.

### CROSS-REFERENCE TO RELATED APPLICATIONS

This application is a continuation of International Application No. PCT/FR2014/051837, filed on Jul. 17, 2014, which claims the benefit of FR 13/57005, filed on Jul. 17, 2013. The disclosures of the above applications are incorporated herein by reference.

### FIELD

The present disclosure concerns an electric thrust reverser system for an aircraft engine nacelle and an aircraft engine nacelle equipped with the same.

### BACKGROUND

In the state of the art, there is known a type of thrust reversers the thrust reverser mechanism of which is maneuvered by means of electric motors.

In particular, two types of thrust reverser mechanisms are commonly known: the door-type thrust reversers and the cascade-type thrust reversers. In order to manoeuver these mechanisms, there are cylinders which can be driven, on command, by an electric motor.

In the case of a door-type thrust reverser, a system intended to lock the doors is provided, which system includes control components and locks which allow connecting each door to a fixed structure of the nacelle. When the command for actuating the doors of the thrust reverser is emitted, the locking system of the thrust reverser doors is then deactivated by its control components, and afterwards, a command is emitted, which command sets the doors of the thrust reverser in motion toward an active position, by means of the cylinders.

Afterwards, a reverse command is emitted in order to deactivate the thrust reverser by retracting the doors of the thrust reverser in a direct propulsion position, by means of the cylinders, and then, reactivating the locking system.

According to different motions, a similar process applies to the cascade-type thrust reverser, a movable cowl being actuated in translation so as to uncover or cover cascade vanes.

The succession of these different steps and the involvement of numerous different components make these systems particularly complex, and this is even more as safety regulatory constraints impose the compliance with standards which often make this multiplication of components and elements (components redundancy) necessary.

Cylinders, which are intended to actuate thrust reverser mechanisms, such as doors or cascades, have to be coupled to these mechanisms. Thus, a high number of actuating components, which components consist mainly of locks and cylinders, is present in the electric thrust reverser system.

It is moreover known to configure the control and locking system of the electric thrust reverser system into several lines of defense, and in particular, a mechanical, an electronic (control) and electrical lines of defense. Hence, an electric thrust reverser system is also compelled to adopt a safety architecture.

### SUMMARY

The present disclosure provides an architecture of an electric thrust reverser which may be integrated in an electrical and control system of an aircraft engine nacelle so as to provide a control which is simple and robust and which enhances its reliability.

The present disclosure provides an electric thrust reverser system for an aircraft engine nacelle, of a type including at least one mechanism for actuating a thrust reverser mechanism, such as a thrust reverser door. The actuating mechanism includes a first and a second drive cylinders, each cylinder including a mechanical connection casing, a primary lock and a movable rod secured to a point connected to the associated thrust reverser mechanism, such as a thrust reverser door, a motor-actuated drive unit being mechanically connected, via flexible shafts, to the mechanical connection casing of each cylinder of the actuating mechanism and set in motion by the command of a control unit via an electrical connection and a tertiary lock for securing the associated thrust reverser mechanism, such as a thrust reverser door, to a fixed structure of the nacelle.

According to the present disclosure, the primary lock is integrated to the drive cylinder, the drive cylinder being of the lost-motion type.

Thus, by integrating the primary locking system into the actuating cylinder, it is possible to combine two components into a single one. The overall architecture and its control are thereby simplified.

In fact, published U.S. patent application numbers 2007/0220998 and US2009/0090204 describe, a special cylinder which provides an additional locking function which is performed during the first revolutions of the cylinder.

A special design mechanism, called the “lost-motion”-mechanism, allows unlocking the cylinder, in a first step, and then, after unlocking is achieved, extending the movable rod of the cylinder itself. As the thrust reverser mechanism is closed, which mechanism is connected to the cylinder, the rod of the cylinder retracts inside the body of the cylinder. Then, at some point, the locking mechanism is activated again during the last revolutions of the input shaft of the cylinder.

Such a special cylinder may be used in the context of a thrust reverser actuating system while complying with safety standards by implementing three mechanical, electronic and electrical lines of defense thanks to an appropriate system which uses both the resources of the propulsion unit (engine/nacelle) and the resources of the aircraft. It should be noted that there any additional computer may not be necessary.

According to other additional features:
the various thrust reverser mechanisms, such as thrust reverser doors, are mechanically connected and one single tertiary lock is disposed in connection with one of the door actuating mechanisms or, more generally, with an associated thrust reverser mechanism;
the control unit is configured so as to constitute the system into three lines of defense, structured into three levels, comprising: at the commands level, a command from the controller of the motor associated to the thrust reverser being confirmed by a command from each of at least two computers of the aircraft and/or the engine and/or the nacelle so as to provide a functional redundancy, at the mechanical level, the three locks, which locks comprise two primary locks and one tertiary lock, being unlocked, at the electric power supply level, three different electric power supply sources being disposed so that the thrust reverser system operates, which sources comprise a high-power source, a low-power source and a source dedicated to the tertiary lock, so that, if one single line of defense is not unlocked, the deployment of the thrust reverser is blocked;
the thrust reverser system being of the type including two thrust reverser mechanisms such as mechanisms for actuating a thrust reverser door, the control unit of the thrust reverser includes a processing core which transmits commands to a direct current processor connected to a direct power control module connected in parallel to two inverters which deliver, via connections, the alternating electric power to the motor-actuated drive unit of each thrust reverser mechanism, the direct power control module receiving information from position and proximity sensors of the different cylinders of the thrust reverser mechanisms so that the commands of the digital processing core produce current ramps such as to manage the actuation of the thrust reverser mechanisms are driven by the motor-actuated drive units;
the digital processing core also controls a control circuit of the brakes associated to the actuating mechanisms of the thrust reverser mechanisms, such as thrust reverser doors, and programmed based, in particular, on the current ramps, which are applied by the direct power control module under the control of the digital processing core, and on position and proximity data which are received from the sensors of the various actuating mechanisms of the thrust reverser mechanisms, such as thrust reverser doors;
a first line of defense includes one tertiary lock associated to a thrust reverser mechanism, such as a thrust reverser door, in the case where the two thrust reverser mechanisms are coupled to each other, or two tertiary locks associated to each of the thrust reverser mechanisms in the case where these are mechanically independent of each other, a second line of defense includes first and second primary locks associated in a first door drive mechanism, and a third line of defense includes first and second primary locks associated in a second door drive mechanism;
at the power supply sources level, the high-power and low-power supply sources are composed in a combiner the outlet of which is connected in parallel to the two motor-actuated drive units;
the first line of defense also includes at the power supply sources level a tertiary lock power supply connected to the tertiary lock via a controlled switch which receives a command from the commands level of a first computer of the aircraft, the second line of defense also includes a second computer of the aircraft for controlling a controlled switch on the power supply source and the third line of defense includes a power supply source which is controlled by a control computer of the engine.

The present disclosure also concerns a nacelle for an aircraft engine equipped with a thrust reverser. According to the present disclosure, the nacelle includes a thrust reverser system according to the present disclosure.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 represents the main elements of an electric thrust reverser in one form of the present disclosure;

FIG. 2 represents a portion of a thrust reverser control computer used in the form of FIG. 1;

FIG. 3 represents one form of an electromechanical portion of the thrust reverser of FIG. 1; and

FIG. 4 represents one form of a driver module of the thrust reverser control computer used in the form of FIG. 1.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

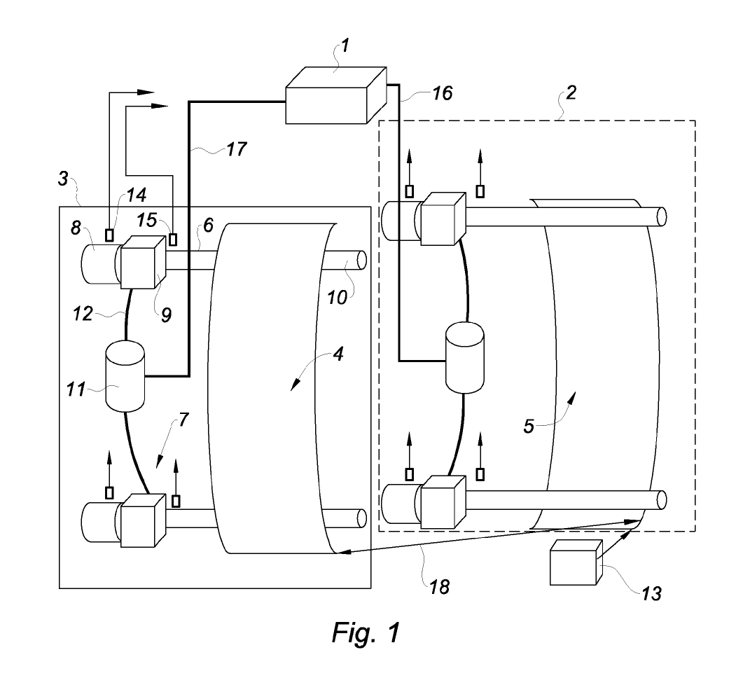

In FIG. 1, there is represented the certain elements of an electric thrust reverser in one form of the present disclosure. In this form, the thrust reverser mechanisms consist of two doors 4 and 5, disposed on each side of the nacelle (not represented) of the aircraft engine. The two doors 4 and 5 slide along a longitudinal axis (not represented) of the nacelle so as to uncover the secondary channel which is intended to deflect the jet coming from the fan of the aircraft engine and redirect it forward in opposition to the direction of flight.

Each door 4 or 5 is actuated by its own mechanism 2 or 3, these mechanisms being substantially identical to each other. In the form of FIG. 1, the door 3 actuating mechanism, which is identical to the door 2 actuating mechanism, includes two cylinders 6 and 7 the rod of which is movable in translation and connected to a point of the door 4 so as to drive it in the desired motion when the thrust reverser is actuated. The two cylinders 6 and 7 are substantially identical to each other and only the cylinder 6 will be described.

Hence, the cylinder 6 includes a movable rod 10 which is retracted and deployed from a casing 9 for mechanical connection to a motor-actuated drive unit 11, which drive unit allows actuating the cylinder 6. The mechanical connection of the motor-actuated drive unit 11 to the mechanical connection casing 9 is provided via a flexible shaft 12. The motor-actuated drive unit 11 is common to the two cylinders 6 and 7 so that their motions are perfectly synchronized, to the extent permitted by the mechanical clearances.

The door actuating cylinder 6, which is identical to the cylinder 7, includes a primary lock 8, a mechanical connection casing 9 and a cylinder rod 10 which can be retracted and deployed from the body of the cylinder under the action of the mechanical connection casing 9. The cylinder rod 10 presents a free end which is secured to a determined point of the door 4 of the thrust reverser. The body of the cylinder 6 is secured to a structure of the nacelle (not represented) which is fixed with respect to the door of the thrust reverser.

In other forms, the thrust reverser mechanism does not include doors, but cascades instead. The door actuating mechanism may then be converted into a mechanism for actuating a cascade of the thrust reverser, in light of the information that is disclosed in the present disclosure.

The door actuating cylinder 6 also includes a primary lock 8 which includes a movable portion (not represented) which cooperates, in a mechanical locking relationship, with a determined portion (not represented) of the structure of the nacelle (not represented) which is fixed with respect to the door 4 of the thrust reverser. In one form, the primary lock is integrated directly to the cylinder by implementing the lost-motion technique, which technique is described, in particular, in published U.S. patent application number 2007/0220998, which is incorporated herein by reference in its entirety.

The door actuating mechanism of the thrust reverser is placed under the control of a control unit 1 of the thrust reverser 1. To this end, each door 2, 3 actuating mechanism is connected to the control unit of the thrust reverser 1 via an electrical connection 16 or 17 which supplies it with power and exchanges information with it.

The electrical connection 17, which starts from the control unit 1 of the thrust reverser and which supplies the door 3 actuating mechanism with power, is, in particular, connected to the motor-actuated drive unit 11 to which it conveys electric power and all drive commands configured for actuating the door 4.

The electrical connection 17, which starts from the control unit 1 of the thrust reverser and connects it to the door 3 actuating mechanism, is also connected to the primary lock 8 so as to control the locked, respectively unlocked, condition of the primary lock 8. In one form of the present disclosure, the actuating cylinder 6 being of the lost-motion type, as has been exposed before, the locking or the unlocking of the primary lock being controlled by the start-up command of the motor-actuated drive unit 11. In fact, in the lost-motion type cylinder, the primary lock is actually integrated in the cylinder and it is activated during the first revolutions of the motor-actuated drive unit 11.

The cylinder 6 of the door 3 actuating mechanism also includes a proximity sensor 14, which is disposed in connection with the primary locking device 8, and a position sensor 15, which is associated to the movable rod 10, the signals of both sensors being transmitted, detected, shaped and used by the control unit 1 of the thrust reverser 1.

Finally, the thrust reverser of the present disclosure includes at least one tertiary lock 13 which allows performing a locking function in parallel with the first and second primary locks of the cylinders of a door 2, 3 actuating mechanism. In fact, in the form of FIG. 1, the motions of the two doors 4 and 5 are mechanically related, for example by means of a link mechanism, which is schematically represented by the arrow 18. In such an form, one single tertiary lock 13 is provided.

In other forms, the two doors 4 and 5 are mechanically independent of each other. There is then provided another tertiary lock which is identical to the tertiary lock 13. The tertiary lock(s) include(s) a mechanism which is movable under the action of a command applied by the control unit 1 of the thrust reverser and which allows connecting or separating a determined point of the door 5 and a point of the structure of the nacelle (not represented) which is fixed with respect to the door 5.

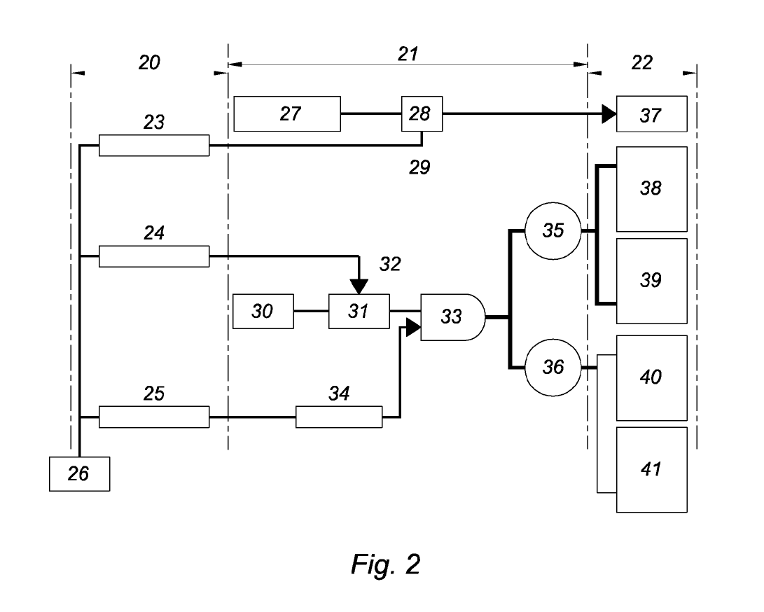

In FIG. 2, there is represented a portion of a control computer of a thrust reverser which is used in the form of FIG. 1.

According to one aspect of the present disclosure, the electric thrust reverser system is constructed into three lines of defense each of which presenting:
a control level 20;
a power level 21; and
an electromechanical level 22.

A line of defense consists of a safety which is involved in the activation of the thrust reverser. Regulations impose the implementation of three safeties at each stage. As regards the operation of the thrust reverser, without these three safeties being unlocked, the thrust reverser will not function.

A first line of defense is composed in the control level by a first computer 23, intended to control the operation of the thrust reverser, which computer is connected in the second power level 21 by a power supply circuit 27 of the tertiary lock, which circuit delivers the power that is required for the operation of the tertiary lock through a controlled switch 28, which switch is controlled by a control port 29 via a control line, which line starts from the first computer 23 for controlling the operation of the thrust reverser. The first line of defense, which is constructed around the tertiary lock, is not affected by the lines of defense (see below) which are associated to the lost-motion cylinders, so that the control of the controlled switch 28 is distinct from the controls of the electric motors which are associated to the lost-motion cylinders of the primary locks since it is the aircraft computer which is used. The first line of defense in the third electromechanical level includes an electromagnet of the tertiary lock 37 itself, which electromagnet is supplied with power via an output terminal of the controlled switch 28. The first computer 23, intended to control the operation of the thrust reverser, is structurally different from the engine and nacelle computers in order to comply with a functional independence requirement.

A second line of defense is composed in the control level 20 by a second computer 24, intended to control the operation of the thrust reverser, which computer is connected in the second power level to the control port 32 of a controlled switch 31. The controlled switch 31 is supplied with power by an electric power supply circuit 30. The outlet of the controlled switch 31 is connected to a combiner 33 the outlet of which is connected in parallel to the motor-actuated drive units 35 and 36 of the door actuating mechanisms. In particular, the motor-actuated drive unit 35 of FIG. 2 corresponds to the motor-actuated drive unit 11 of the mechanism 3 of FIG. 1. The second line of defense in the third electromechanical level 22 includes a first primary lock 38 and a second primary lock 39. The first primary lock 38 of FIG. 2 corresponds to the lock 8 of the cylinder 6 of the door 3 actuating mechanism, whereas the second primary lock 39 of FIG. 2 corresponds to the lock (with no reference numeral) of the cylinder 7 of the door 3 actuating mechanism.

A third line of defense is composed in the control level 20 by a computer 25, intended to control the engine which is associated to the thrust reverser, and which is connected in the second power level to an input port of a control unit of the thrust reverser 34, an output control line of which is connected to a second input of the described combiner 33 so as to realize the second line of defense. The output terminal of the combiner 33 is connected in parallel to the motor-actuated drive units 35 and 36 of the door actuating mechanisms. In particular, the motor-actuated drive unit 36 of FIG. 2 corresponds to the motor-actuated drive unit of the mechanism 2 of FIG. 1. The third line of defense in the third electromechanical level 22, includes a first primary lock 40 and a second primary lock 41. The first primary lock 40 of FIG. 2 corresponds to the lock of the first cylinder (with no reference numeral) of the door 3 actuating mechanism, whereas the second primary lock 41 of FIG. 2 corresponds to the lock (with no reference numeral) of the second cylinder of the door 2 actuating mechanism.

It will be noted that, in the context of the present disclosure, in addition to the computers that are required for the operation of the thrust reverser, there is a need for other computers, such as a FADEC computer which already exists, in order to enhance the independence of the control system of the lost-motion cylinders so as to avoid having common control modes.

The tertiary lock is unlocked by a command coming from an aircraft computer, whereas the primary locks are unlocked by the actuating system (or the engine computer). The commands of the primary locks 40 and 41 and those of the tertiary lock 37 are not necessarily in phase.

In the form of FIG. 2, as well as in the form of FIG. 1, the two thrust reverser mechanisms, which in this instance consist of thrust reverser doors, have their motions related to each other. Therefore, only one single tertiary lock is represented in the first line of defense. In another form, in which the two thrust reverser mechanisms, which in this instance consist of thrust reverser doors, have their motions independent of each other, each thrust reverser mechanism, such as a thrust reverser door, is fitted with its own tertiary lock.

The control strategy of the thrust reverser of the present disclosure is as follows. At the commands level, a command of the controller of the engine associated to the thrust reverser is required, which command has to be confirmed by a command from each of the two computers of the aircraft.

At the mechanical level, the three locks, which locks comprise two primary locks and one tertiary lock, have to be unlocked.

At the electric power supply level, the control strategy of the thrust reverser of the present disclosure requires the implementation of three different electric power supply sources in order that the set functions: a high-power source, a low-power source and the source dedicated to the tertiary lock.

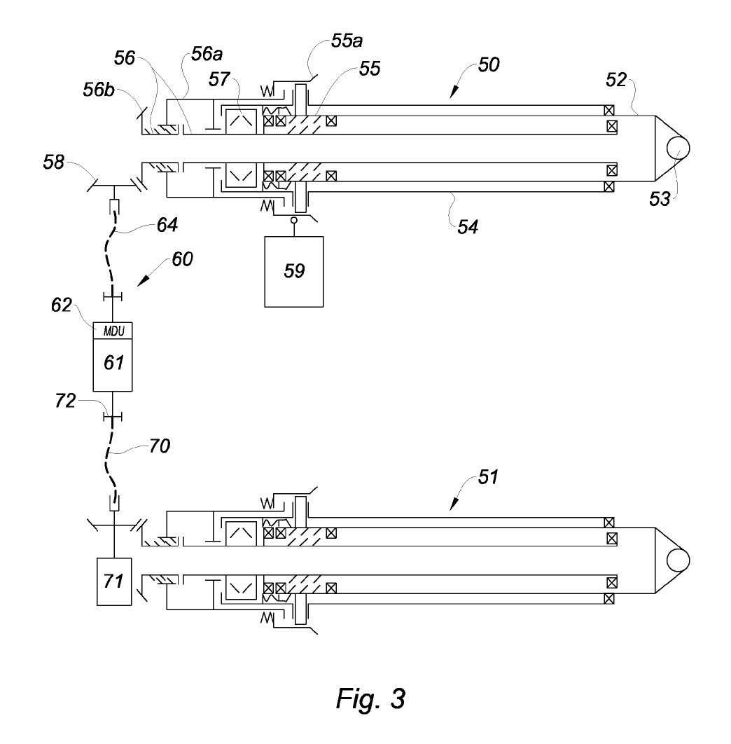

In FIG. 3, there is represented an form of an electromechanical portion of the thrust reverser of FIG. 1 which details, in particular, the two lost-motion cylinders of a thrust reverser actuating mechanism, such as a door actuating mechanism of the type represented in FIG. 1.

The two upper 50 and lower 51 cylinders are substantially identical and only the upper cylinder 50 will be detailed. It includes a movable rod 52 the free end of which carries an eyelet intended to be secured with a fixed point of the thrust reverser door to be driven.

The movable rod 52 is retracted inside the body 54 of the cylinder and ends up on a set of locking segments 55 as is described in particular in the document US-A-2007/0220998. A locking cam 55a, which is biased by springs (which are represented with no reference numeral) allows engaging the segments 55 so as to lock or unlock the movable rod 52. A bearing 57 supports a two-part input shaft 56, a first portion of which passes throughout a fixed casing 56a and carries an input wheel 56a, whereas the second portion passes again throughout the fixed casing 56A and extends inside the movable rod 52 of the cylinder, which is driven by the locking segments 55.

The motor-actuated drive unit 60 essentially includes an electric motor 61 which is supplied with power by the second line of defense or by the third line of defense (FIG. 2). The rotor shaft of the motor 61 is associated to a complementary manual drive mechanism 62 which is intended for manoeuvers during maintenance and technical inspection operations. The rotor shaft of the motor 61 consists of a two-side shaft including outlets which are coupled by a wheel 72 so as to drive a flexible shaft 64 which drives a wheel 58 meshing with the input wheel 56b and a flexible shaft 70 which drives a wheel meshing with the input wheel (with no reference numeral) which is similar to the input wheel 56b of the lower cylinder 51.

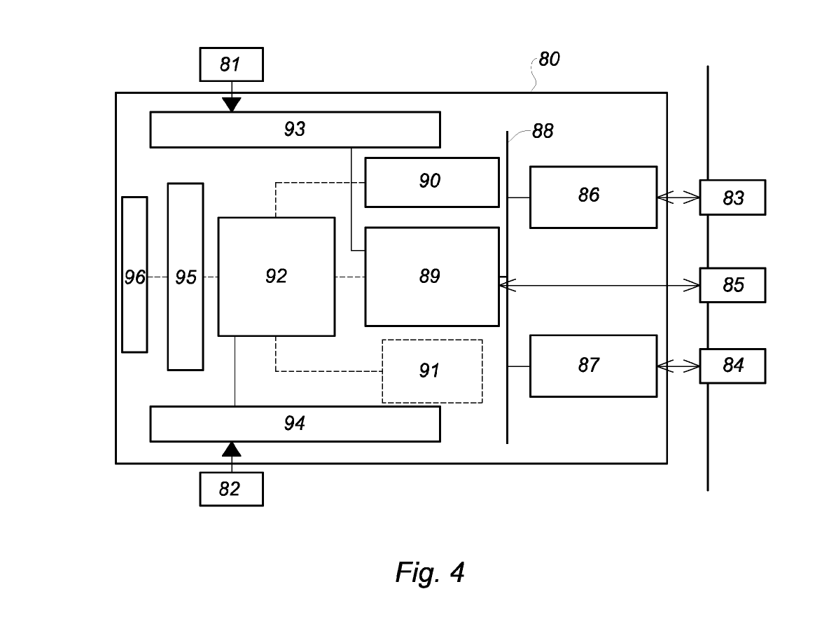

In FIG. 4, there is represented an form of a driver module of the control computer of a thrust reverser which is used in the form of FIG. 1. The control module 80 or unit of the thrust reverser has been represented at 1 in FIG. 1 and is detailed hereinafter.

The power supply network 81 of the aircraft conveys direct current power. However, the network 81 may be of any type. The network 81 is connected, via a network interface, which, in this instance, acts as a direct current regulator 93, to a direct current processor 89 the outlet of which is connected to a direct power control module 89. In general, the network interface 93 is fitted with resources which fulfill the secondary power supply tasks which are necessary to the operation of the power module. Two inverters 86 and 87 are connected in parallel to the outlet of the control module 89, which inverters deliver, via connections 83, 84, the alternating electric power to the drive units, such as the motor-actuated drive unit 11 of the door 3 actuating mechanism of the system of FIG. 1.

Moreover, the direct power control module 89 receives information from the position and proximity sensors 85 of the different cylinders of the system of the present disclosure. It also receives the commands of a digital processing core 92 which allows, in particular, producing the current ramps such as to manage the actuation of the thrust reverser mechanisms are driven by the motor-actuated drive units, such as the unit 11 for the door 3 drive mechanism (FIG. 1). More generally, the power control module 89 allows shaping the current/voltage profiles that are required to drive the mechanism.

The digital processing core 92 also controls a circuit 91 intended to control the brakes associated to the mechanisms, such as doors or cascades of the thrust reverser, which mechanisms are actuated by the door 2, 3 actuating mechanisms in FIG. 1. Such brakes allow controlling docking of the movable elements of the thrust reverser, such as thrust reverser doors, with associated fixed structure of the nacelle. These brakes are programmed based, in particular, on the current ramps, which are applied by the direct power control module 89 under the control of the digital processing core 92, and on position and proximity data which are received from the sensors 85 of the various door 2, 3 actuating mechanisms in FIG. 1.

The digital processing core 92 also controls a power supply circuit 90 of the electrical resources of the nacelle.

Moreover, the control unit 80 of the thrust reverser also includes a regulator 94 which is connected to the direct current low-power network 82 of the aircraft and which is intended to provide the different circuits of the control unit 80 with the proper electrical polarizations.

The module 95 serves as a digital interface with the aircraft which interface enables receiving the commands of the electric thrust reverser system of the present disclosure according to a determined communication protocol such as an IP protocol.

The device 96 consists of a backplane which is realized from an interconnect board which includes, in particular, protections and filters intended to resist lightning effect and provide electromagnetic compatibility.

What is claimed is:

1. An electric thrust reverser system for an aircraft engine nacelle, including at least one actuating mechanism configured to actuate a thrust reverser mechanism, the actuating mechanism including a first drive cylinder and a second drive cylinder, each drive cylinder comprising:
a mechanical connection casing;
a primary lock; and
a movable rod secured to a point connected to the thrust reverser mechanism, a motor-actuated drive unit being mechanically connected, via flexible shafts, to the mechanical connection casings of each of the first and second drive cylinders and set in motion by a command of a control unit via an electrical connection and a tertiary lock for securing the thrust reverser mechanism to a fixed structure of the aircraft engine nacelle, wherein the primary lock is integrated to at least one of the first or second drive cylinders, and at least one of the first or second drive cylinders is of a lost-motion type.

2. The electric thrust reverser system according to claim 1, wherein the electric thrust reverser system comprises a plurality of thrust reverser mechanisms, which are mechanically connected, and one single tertiary lock is disposed in connection with one of the actuating mechanisms or with an associated thrust reverser mechanism.

3. The electric thrust reverser system according to claim 1, wherein the thrust reverser system is configured into lines of defense according to at least three levels:
at a control unit and commands level, a command from a controller of a motor associated to the thrust reverser mechanism being confirmed by a command from each of at least two computers of an aircraft, an engine, or the aircraft engine nacelle so as to provide a functional redundancy,
at a mechanical level, two primary locks and one tertiary lock being unlocked,
at an electric power supply level, three different electric power supply sources being disposed so that the thrust reverser mechanism operates, and comprising a high-power source, a low-power source and a source dedicated to the tertiary lock, so that, when one single line of defense is not unlocked during the activation of the thrust reverser system, a deployment of the thrust reverser mechanism is blocked.

4. The electric thrust reverser system according to claim 3, including two thrust reverser mechanisms, wherein the control unit of the thrust reverser mechanism includes a processing core which transmits commands to a current processor connected to a power control module connected in parallel to two inverters which deliver, via connections, alternating electric power to the motor-actuated drive unit of each thrust reverser mechanism, the power control module receiving information from position and proximity sensors of different cylinders of the thrust reverser mechanisms so that the commands of the processing core produce current ramps such as to manage the actuation of the thrust reverser mechanisms driven by the motor-actuated drive units.

5. The electric thrust reverser system according to claim 4, wherein the processing core controls a control circuit of brakes associated to the actuating mechanisms of the thrust reverser mechanisms, and programmed based on the current ramps which are applied by the power control module under the control of the digital processing core, and on position and proximity data which are received from the sensors of the actuating mechanisms of the thrust reverser mechanisms.

6. The electric thrust reverser system according to claim 3, wherein a first line of defense includes one tertiary lock associated to a thrust reverser mechanism in the case where two thrust reverser mechanisms are coupled to each other, or two tertiary locks associated to each of the thrust reverser mechanisms in the case where the thrust reverser mechanisms are mechanically independent of each other, a second line of defense includes first and second primary locks associated in a first door drive mechanism, and a third line of defense includes first and second primary locks associated in a second door drive mechanism.

7. The electric thrust reverser system according to claim 6, wherein at the electric power supply sources level, the high-power and low-power sources are composed in a combiner an outlet of which is connected in parallel to two motor-actuated drive units.

8. The electric thrust reverser system according to claim 7, wherein the first line of defense also includes at the electric power supply sources level, a tertiary lock power supply connected to the tertiary lock via a controlled switch which receives a command from the commands level of a first computer of the aircraft, the second line of defense also includes a second computer of the aircraft for controlling a controlled switch on the high-power source, and the third line of defense includes the low-power source which is controlled by a control computer of the engine.

9. A nacelle for an aircraft engine equipped with a thrust reverser comprising the electric thrust reverser system according to claim 1.
